(19) United States
(12) Patent Application Publication
(10) Pub. No.: US 2026/0110399 A1
(43) Pub. Date: Apr. 23, 2026

(54) DAMPING TYPE UNIVERSAL ARM SUPPORT

(71) Applicant: Shenzhen Digital Slow Shutter Technology Co., Ltd, Shenzhen (CN)

(72) Inventors: Yunfeng QIAN, Shenzhen (CN); Xuanjuan FAN, Shenzhen (CN)

(21) Appl. No.: 18/951,882

(22) Filed: Nov. 19, 2024

(30) Foreign Application Priority Data
Oct. 22, 2024 (CN) 2024225488390

(51) Int. Cl. F16M 13/04; B25J 9/00; G03B 17/56

(52) U.S. Cl. CPC F16M 13/04; B25J 9/0015; G03B 17/561

(57) ABSTRACT

A damping type universal arm support includes a first assembly and a second assembly which are symmetrically arranged and used for connecting objects; a damping sleeve piece arranged between the first assembly and the second assembly which are movably connected through the damping sleeve piece; and a limiting assembly arranged at the end of the damping sleeve piece and used for limiting the damping sleeve piece and limiting rotation of the first assembly and the second assembly. Through cooperative design of multiple structures, a device can connect two objects through the first assembly and the second assembly which can be subjected to stepless adjustment through the damping sleeve piece, the damping sleeve piece is clamped through the limiting assembly, damping during connection of the first assembly and the second assembly is achieved; the limiting assembly is screwed to limit the rotation of the first assembly and the second assembly.

### FIELD OF THE INVENTION

The present invention relates to the technical field of photographic apparatuses, and particularly relates to a damping type universal arm support.

### BACKGROUND OF THE INVENTION

Cameras, camcorders, and mobile phones, as common devices for recording images, often need a variety of accessories to achieve different shooting effects or to facilitate erection at special positions.

With the demand for more and more personalized image production at present, and under the trend of fast-paced information flow, people have an increasing demand for fast and accurate erection or adjustment of devices, and one of the most commonly used tools is a universal arm, but a traditional universal arm cannot achieve fast and precise adjustment due to structural problems. Therefore, the present application proposes a damping type universal arm support, which provides a new technical solution to solve the above problem of fast and precise adjustment.

### SUMMARY OF THE INVENTION

Based on this, it is necessary to provide a damping type universal arm support to solve the above technical problems. Through the cooperative design of a plurality of structures, a device can connect two objects through a first assembly and a second assembly respectively, the first assembly and the second assembly can be subjected to stepless adjustment through a damping sleeve piece, and the damping sleeve piece can be clamped through a limiting assembly, and therefore, the damping effect during connection of the first assembly and the second assembly is achieved; and the limiting assembly can be screwed to limit the rotation of the first assembly and the second assembly.

In order to solve the above technical problem, the technical scheme adopted in the present invention is as follows:

A damping type universal arm support, which is applied to the connection of objects as well as the angle adjustment of the objects.

The damping type universal arm support comprises:

a first assembly and a second assembly which are symmetrically arranged and are both used for connecting objects;

a damping sleeve piece which is arranged at a position between the first assembly and the second assembly, wherein the first assembly and the second assembly are movably connected through the damping sleeve piece; and

a limiting assembly which is arranged at the end of the damping sleeve piece and is used for limiting the damping sleeve piece and moreover used for limiting the rotation of the first assembly and the second assembly.

As a preferable embodiment of the damping type universal arm support provided by the present invention, the first assembly comprises a first movable arm; an upper end of the first movable arm is sleeved with a first ball head limiting housing; a lower end of the first ball head limiting housing is in threaded connection with the first movable arm through a first fixing screw; a first ball seat is placed at the bottom of the inner side of the first ball head limiting housing; a first ball head is connected to the top of the first ball head limiting housing in a ball hinge mode; a first connecting piece is detachably connected to the top of the first ball head; a first locking screw is arranged at an upper end of the first connecting piece; a first ejector rod is arranged in the first movable arm; an upper end of the first ejector rod penetrates through the first fixing screw to be attached to the bottom of the first ball seat; the first ejector rod is vertically slidably connected to the first fixing screw; a lower end of the first ejector rod extends to the inner side of a lower end of the first movable arm;

the second assembly comprises a second movable arm; an upper end of the first movable arm is sleeved with a second fixing screw; a lower end of the second fixing screw is in threaded connection with the second movable arm through a second ball head limiting housing; a second ball seat is placed at the bottom of the inner side of the second fixing screw; a second ball head is connected to the top of the second fixing screw in a ball hinge mode; a second connecting piece is detachably connected to the top of the second ball head; a second locking screw is arranged at an upper end of the second connecting piece; a second ejector rod is arranged in the second movable arm; an upper end of the second ejector rod penetrates through the second ball head limiting housing to be attached to the bottom of the second ball seat; the second ejector rod is vertically slidably connected to the second ball head limiting housing; and a lower end of the second ejector rod extends to the inner side of a lower end of the second movable arm.

As a preferable embodiment of the damping type universal arm support provided by the present invention, the damping sleeve piece comprises a cone pressing sheet, an expansion sleeve limiting housing, and an expansion sleeve; the cone pressing sheet is in inserted connection with the bottom of one side of the first movable arm; the expansion sleeve limiting housing is in inserted connection with the bottom of one side of the second movable arm; a first cover is arranged on the outer side of the first movable arm; the outer side of the cone pressing sheet is sleeved with the first cover; the first cover is fixedly connected to the first movable arm through a screw; the outer side of the expansion sleeve limiting housing is sleeved with a second cover; the second cover is fixedly connected to the second movable arm through a screw; the expansion sleeve is placed in the expansion sleeve limiting housing; the end, away from the first movable arm, of the cone pressing sheet stretches into the expansion sleeve limiting housing; and the end, located on the inner side of the expansion sleeve limiting housing, of the cone pressing sheet is attached to the inner side of one end of the expansion sleeve.

As a preferable embodiment of the damping type universal arm support provided by the present invention, the limiting assembly comprises a bevel nut, a bevel sliding block, and a locking wrench; one end of the bevel nut stretches into the inner side of the lower end of the first movable arm and sequentially penetrates through the cone pressing sheet, the first cover, the expansion sleeve and the expansion sleeve limiting housing to extend to the inner side of the lower end of the second movable arm; the end, located on the inner side of the lower end of the first movable arm, of the bevel nut is arranged to be a bevel; a lower end of the first ejector rod is attached to the bevel of the end of the bevel nut; the bevel sliding block is placed in the lower end of the second movable arm; the end, close to the bevel nut, of the bevel sliding block is arranged to be a bevel; the lower end of the second ejector rod is attached to the bevel of the end of the bevel sliding block; one end of the locking wrench penetrates through the bevel sliding block to stretch into the bevel nut; and the locking wrench is in threaded connection with the bevel nut.

As a preferable embodiment of the damping type universal arm support provided by the present invention, the outer side of the locking wrench is in threaded connection with a decoration cover.

As a preferable embodiment of the damping type universal arm support provided by the present invention, the expansion sleeve is arranged to be a hollow cylinder, and expansion grooves are alternately formed in two ends of the expansion sleeve; the inner side of the end, close to the cone pressing sheet, of the expansion sleeve is arranged to be a cone; and the bevel is attached to the surface of the cone pressing sheet.

As a preferable embodiment of the damping type universal arm support provided by the present invention, the expansion sleeve is arranged to be a hollow cylinder; a splitting through groove is formed in one side of the expansion sleeve in an axis direction; a connecting rod is inserted in the splitting through groove; and the end, away from the expansion sleeve, of the connecting rod is in inserted connection with the cone pressing sheet.

Compared with the prior art, the present invention has the following beneficial effects.

According to the damping universal arm support provided by the present invention, through the cooperative design of a plurality of structures, a device can connect two objects through the first assembly and the second assembly, the first assembly and the second assembly can be subjected to stepless adjustment through the damping sleeve piece, and the damping sleeve piece can be clamped through the limiting assembly, and therefore, the damping effect during connection of the first assembly and the second assembly is achieved; and the limiting assembly can be screwed to limit the rotation of the first assembly and the second assembly.

According to the damping type universal arm support provided by the present invention, through the cooperative design of the plurality of structures, the device can realize stepless adjustment of the locking force and hovering under an allowable weight, and thus a user can adjust the angle of device in real time in use without loosening or locking a fixing rotary knob again.

### BRIEF DESCRIPTION OF THE DRAWINGS

In order to explain the technical solutions in the embodiments of the present invention or the prior art more clearly, the drawings needing to be used in the descriptions of the embodiments or the prior art are briefly introduced hereinafter. Obviously, the drawings in the following descriptions are only exemplary, and for those of ordinary skills in the art, other drawings may also be derived and obtained based on the provided drawings without going through any creative work.

FIG. 1 is an overall structural schematic diagram of a damping type universal arm support provided by the present invention;

FIG. 2 is a structural schematic diagram of a first assembly, a second assembly, a damping sleeve piece, and a limiting assembly of a damping type universal arm support provided by the present invention;

FIG. 3 is a cross-sectional view of an overall structure of a damping type universal arm support provided by the present invention;

FIG. 4 is a structural schematic diagram of connection of a first assembly, a second assembly, a damping sleeve piece, and a limiting assembly of a damping type universal arm support provided by the present invention;

FIG. 5 is a structural schematic diagram of a damping sleeve piece, and a limiting assembly of a damping type universal arm support provided by the present invention;

FIG. 6 is a structural schematic diagram of one expansion sleeve of a damping type universal arm provided by the present invention; and

FIG. 7 is a structural schematic diagram of another expansion sleeve of a damping type universal arm provided by the present invention.

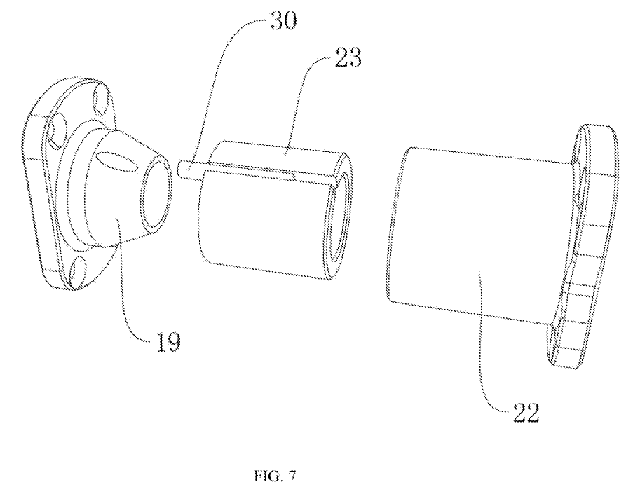

Reference numerals are as follows:

1 refers to first locking screw; 2 refers to second locking screw; 3 refers to first connecting piece; 4 refers to second connecting piece; 5 refers to first ball head; 6 refers to second ball head; 7 refers to first ball seat; 8 refers to second ball seat; 9 refers to first fixing screw; 10 refers to second fixing screw; 11 refers to first ball head limiting housing; 12 refers to second ball head limiting housing; 13 refers to first ejector rod; 14 refers to second ejector rod; 15 refers to first movable arm; 16 refers to second movable arm; 17 refers to bevel nut; 18 refers to bevel sliding block; 19 refers to cone pressing sheet; 20 refers to first cover; 21 refers to second cover; 22 refers to expansion sleeve limiting housing; 23 refers to expansion sleeve; 24 refers to locking wrench; 25 refers to decoration cover; 26 refers to first assembly; 27 refers to second assembly; 28 refers to damping sleeve piece; 29 refers to limiting assembly; and 30 refers to connecting rod.

### DETAILED DESCRIPTION OF SOME EMBODIMENTS

In order to make the objectives, the technical solutions and the advantages of the embodiments of the present application more clear, the technical solutions in the embodiments of the present application will be illustrated clearly and completely hereinafter with reference to the accompanying drawings in the embodiments of the present application. Apparently, the embodiments described are merely some but not all of the embodiments of the present application. Based on the embodiments of the present application, all other embodiments obtained by those of ordinary skills in the art without going through any creative work should fall within the scope of protection of the present application.

As described in the Background Art, a conventional universal arms cannot achieve fast and precise adjustment due to structural problems.

In order to solve this technical problem, the present invention provides a damping type universal arm support, which is applied to the connection of objects as well as the angle adjustment of the objects.

In order to facilitate those skilled in the art to better understand the solution of the present invention, the technical solution in the embodiments of the present invention will be clearly and completely described below in conjunction with the accompanying drawings.

### Embodiment 1:

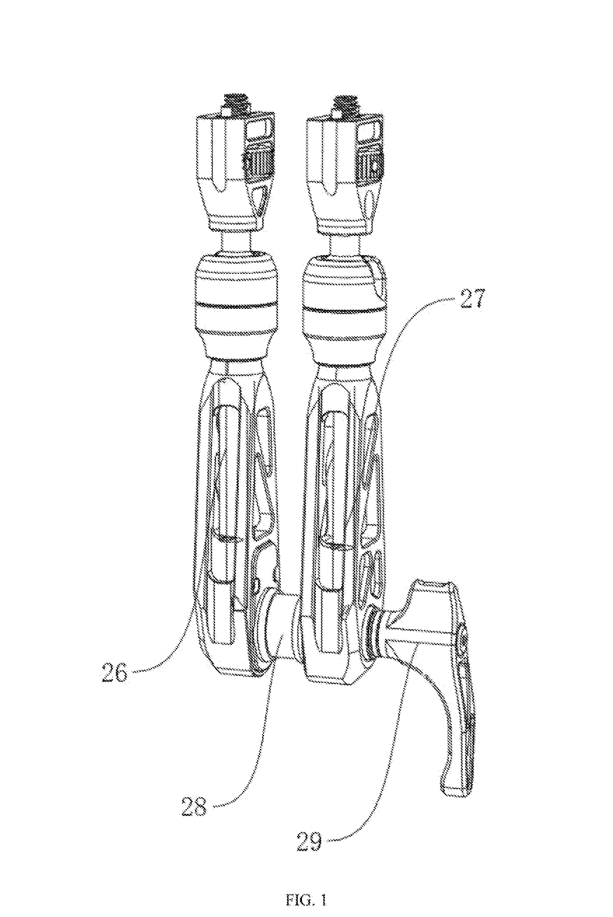

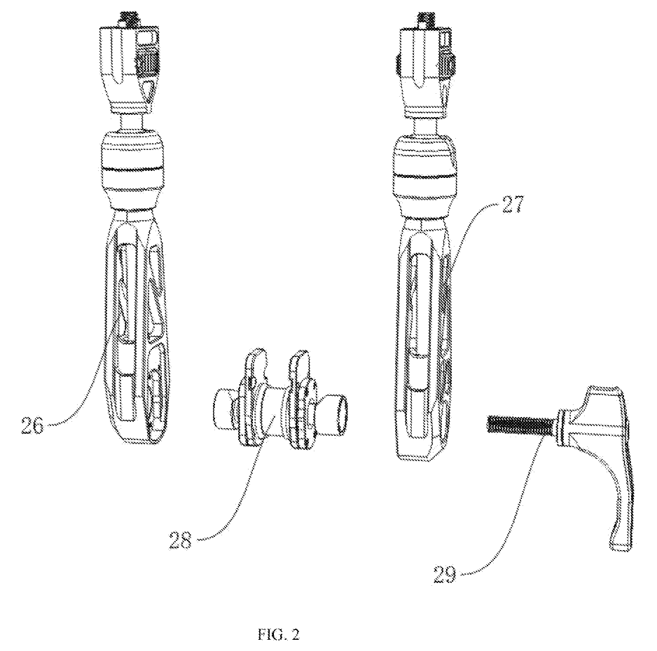

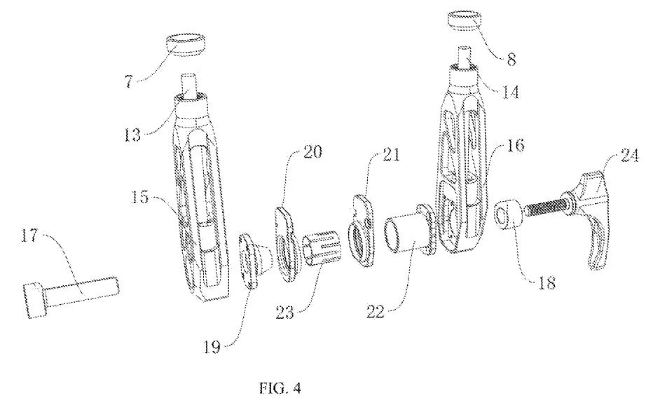

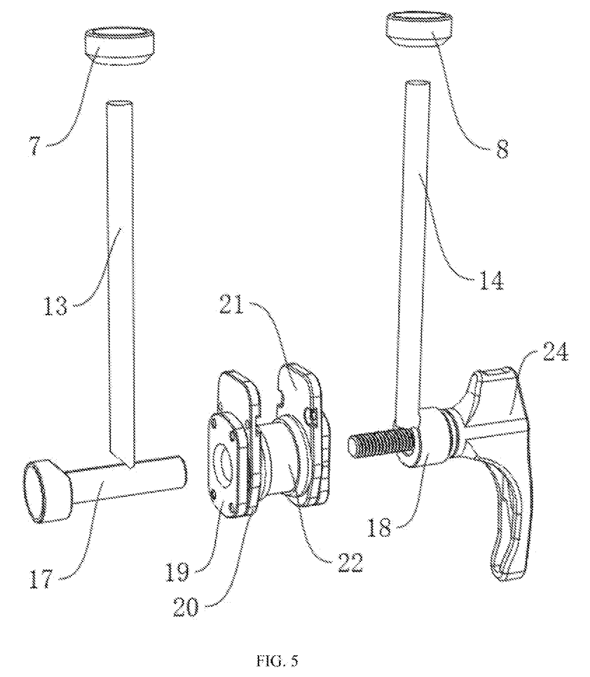

As shown in FIG. 1-FIG. 6, a damping type universal arm support includes:

a first assembly 26 and a second assembly 27 which are symmetrically arranged and are both used for connecting objects;

a damping sleeve piece 28 which is arranged at a position between the first assembly 26 and the second assembly 27, in which, the first assembly 26 and the second assembly 27 are movably connected through the damping sleeve piece 28; and

a limiting assembly 29 which is arranged at the end of the damping sleeve piece 28 and is used for limiting the damping sleeve piece 28 and moreover used for limiting rotation of the first assembly 26 and the second assembly 27.

Specifically, the first assembly 26 includes a first movable arm 15; an upper end of the first movable arm 15 is sleeved with a first ball head limiting housing 11; a lower end of the first ball head limiting housing 11 is in threaded connection with the first movable arm 15 through a first fixing screw 9; a first ball seat 7 is placed at the bottom of the inner side of the first ball head limiting housing 11; a first ball head 5 is connected to the top of the first ball head limiting housing 11 in a ball hinge mode; a first connecting piece 3 is detachably connected to the top of the first ball head 5; a first locking screw 1 is arranged at an upper end of the first connecting piece 3; a first ejector rod 13 is arranged in the first movable arm 15; an upper end of the first ejector rod 13 penetrates through the first fixing screw 9 to be attached to the bottom of the first ball seat 7; the first ejector rod 13 is vertically slidably connected to the first fixing screw 9; a lower end of the first ejector rod 13 extends to the inner side of a lower end of the first movable arm 15;

Specifically, the second assembly 27 includes a second movable arm 16; an upper end of the first movable arm 15 is sleeved with a second fixing screw 10; a lower end of the second fixing screw 10 is in threaded connection with the second movable arm 16 through a second ball head limiting housing 12; a second ball seat 8 is placed at the bottom of the inner side of the second fixing screw 10; a second ball head 6 is connected to the top of the second fixing screw 10 in a ball hinge mode; a second connecting piece 4 is detachably connected to the top of the second ball head 6; a second locking screw 2 is arranged at an upper end of the second connecting piece 4; a second ejector rod 14 is arranged in the second movable arm 16; an upper end of the second ejector rod 14 penetrates through the second ball head limiting housing 12 to be attached to the bottom of the second ball seat 8; the second ejector rod 14 is vertically slidably connected to the second ball head limiting housing 12; and a lower end of the second ejector rod 14 extends to the inner side of a lower end of the second movable arm 16.

Specifically, the damping sleeve piece 28 includes a cone pressing sheet 19, an expansion sleeve limiting housing 22, and an expansion sleeve 23; the cone pressing sheet 19 is in inserted connection with the bottom of one side of the first movable arm 15; the expansion sleeve limiting housing 22 is in inserted connection with the bottom of one side of the second movable arm 16; a first cover 20 is arranged on the outer side of the first movable arm 15; the outer side of the cone pressing sheet 19 is sleeved with the first cover 20; the first cover 20 is fixedly connected to the first movable arm 15 through a screw; the outer side of the expansion sleeve limiting housing 22 is sleeved with a second cover 21; the second cover 21 is fixedly connected to the second movable arm 16 through a screw; the expansion sleeve 23 is placed in the expansion sleeve limiting housing 22; the end, away from the first movable arm 15, of the cone pressing sheet 19 stretches into the expansion sleeve limiting housing 22; and the end, located on the inner side of the expansion sleeve limiting housing 22, of the cone pressing sheet 19 is attached to the inner side of one end of the expansion sleeve 23.

Specifically, the limiting assembly 29 includes a bevel nut 17, a bevel sliding block 18, and a locking wrench 24; one end of the bevel nut 17 stretches into the inner side of the lower end of the first movable arm 15 and sequentially penetrates through the cone pressing sheet 19, the first cover 20, the expansion sleeve 23 and the expansion sleeve limiting housing 22 to extend to the inner side of the lower end of the second movable arm 16; the end, located on the inner side of the lower end of the first movable arm 15, of the bevel nut 17 is arranged to be a bevel; a lower end of the first ejector rod 13 is attached to the bevel of the end of the bevel nut 17; the bevel sliding block 18 is placed in the lower end of the second movable arm 16; the end, close to the bevel nut 17, of the bevel sliding block 18 is arranged to be a bevel; the lower end of the second ejector rod 14 is attached to the bevel of the end of the bevel sliding block 18; one end of the locking wrench 24 penetrates through the bevel sliding block 18 to stretch into the bevel nut 17; and the locking wrench 24 is in threaded connection with the bevel nut 17. Further, the outer side of the locking wrench 24 is in threaded connection with a decoration cover 25.

Through the above structure design, the cone pressing sheet 19 is placed into the first movable arm 15 and pressed with the first cover 20; the second cover 21, the expansion sleeve limiting housing 22 and the second movable arm 16 are mounted in the same mode; and then the expansion sleeve 23 is placed into the expansion sleeve limiting housing 22 and connected to the cone pressing sheet 19. The bevel nut 17 penetrates through any one of the mounted assemblies, the bevel sliding block 18 is mounted on the other assembly; then the locking wrench 24 is connected to the bevel nut 17 through threads, and meanwhile, the first assembly 26 and the second assembly 27 are fixed into an integrated assembly with a rotatable rotating shaft in the middle; the first ball head 5 penetrates through the first ball head limiting housing 11 and then is mounted into the first ball seat 7, at the moment, it is needed to insert the first ejector rod 13 into the mounted first movable arm 15 and connect the first ball head 5, the first ball seat 7 and the first ball head limiting housing 11 to the mounted first movable arm 15 through the first fixing screw 9, and the same mounting mode is performed on the other side. Finally, the first locking screw 1 penetrates through the first connecting piece 3 to realize connection, and the first connecting piece 3 and the first ball head 5 are connected together through the screw; and the same mounting mode is performed on the other side.

Under a condition that the locking wrench 24 and the bevel nut 17 are not screwed, the bevel nut 17 and the bevel sliding block 18 cannot apply pressure to the first ejector rod 13 and the second ejector rod 14, and the rotating shaft part in the middle cannot realize full contact through the tension between the locking wrench 24 and the bevel nut 17, so that ball surfaces of the first ball head 5 and the second ball head 6, and rotating shafts of the cone pressing sheet 19, the expansion sleeve limiting housing 22 and the expansion sleeve 23 are in a movable state at the moment, and a user can adjust the angles of the first assembly 26 and the angle of the second assembly 27 at this state.

During operation, only a locking operation is needed to perform on the locking wrench 24, and the bevel nut 17 can be tensioned to reduce the distance therebetween, and meanwhile, the bevel sliding block 18 is extruded; because the bevel nut 17 and the bevel sliding block 18 are provided with connected bevels which have the same angle as the first ejector rod 13 and the second ejector rod 14, when the bevel nut 17 and the bevel sliding block 18 are subjected to the pressure produced by locking of the locking wrench 24, the bevels will guide part of the force upwards through the first ejector rod 13 and the second ejector rod 14, and at the moment, when the first ball seat 7 and the second ball seat 8 which are correspondingly connected to the first ejector rod 13 and the second ejector rod 14 are subjected to the upward guiding force, the ball heads of the first ball head 5 and the second ball head 6 will be pushed to the second fixing screw 10 and the first ball head limiting housing 11, and the overall movement will be stopped under the limitation of the second fixing screw 10 and the first ball head limiting housing 11.

Moreover, because the distance between the locking wrench 24 and the bevel nut 17 is reduced, the cone pressing sheet 19, the expansion sleeve limiting housing 22 and the expansion sleeve 23 will be extruded at the same time; because the expansion sleeve 23 has a bevel taper and is provided with an elastic part with an expansion design, the expansion sleeve 23 will expand towards the periphery under the extrusion of the cone pressing sheet 19 with the same angle, and at the moment, the expansion range will be limited in the expansion sleeve limiting housing 22. Force is continuously applied to the locking wrench 24, the first ball head 5 and the second ball head 6 will be locked under the pushing of the first ball seat 7 and the second ball seat 8 and the limitation of the second fixing screw 10 and the first ball head limiting housing 11, and moreover, the cone pressing sheet 19 will expand the expansion sleeve 23 to lock the expansion sleeve limiting housing 22 under the continuous extrusion force.

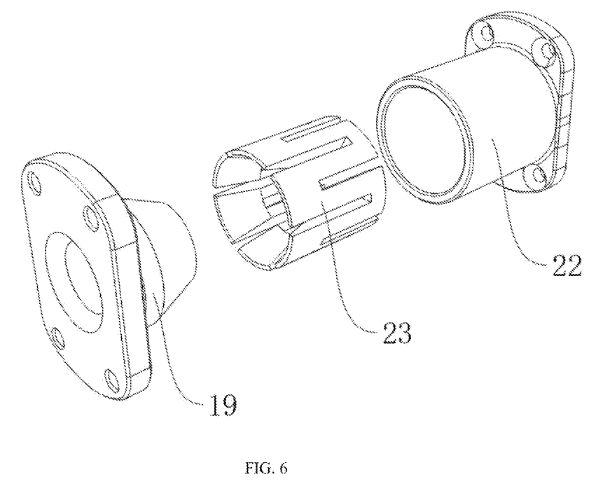

Through the above structure design, because the middle part that is the expansion sleeve 23 is designed to be an elastic expansion connecting piece shown in FIG. 6, when force at different magnitudes is applied to the locking wrench 24, the locking force that can be provided by the expansion sleeve 23 is different; in a limit test, after about 10 kg of pressure is applied to the locking wrench 24, the middle can bear 1.5 Nm of rotating torsion, the ball heads at the two ends can bear the maximum 8 kg of loads under the shortest force arm, the ball heads can bear the minimum 5 kg of loads under the longest force arm, and at the moment, the maximum locking force is achieved. When the locking wrench 24 is gradually released, due to the shrinkage of the elastic expansion connecting piece and the decrease of the upward guide force of the first ejector rod 13 and the second ejector rod 14, the rotating shaft and the ball heads will be in a state with friction damping at the moment; when bearing some light devices, the devices can be hovered at any angle, the angle and the position can also be adjusted in real time, and a situation that the adjustment can be carried out only through complete unlocking just like a traditional universal arm is avoided.

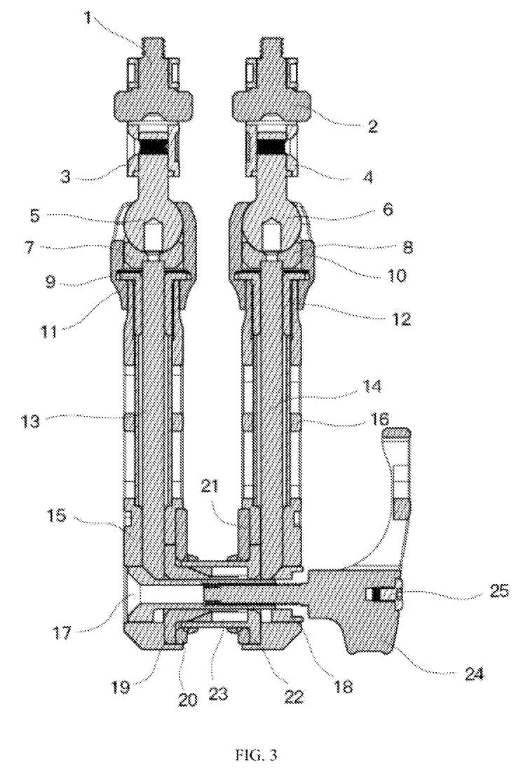

Through the above structure design, a replaceable inserting groove structure is designed for the first ball head 5 and the second ball head 6 as shown in FIG. 3 according to the present invention, side mounting screw holes are reserved in the first ball head 5 and the second ball head 6, and connected accessory connectors can be replaced by disassembling the screws, thus realizing compatibility with different sizes or achieve different functions. The mode of machining the mounting screw holes in the side is more stable than a traditional mode of fixing connectors through threads and glue.

### Embodiment 2:

The damping type universal arm support provided in the Embodiment 1 is further optimized, specifically, as shown in FIG. 6, the expansion sleeve 23 is arranged to be a hollow cylinder, and expansion grooves are alternately formed in two ends of the expansion sleeve 23; the inner side of the end, close to the cone pressing sheet 19, of the expansion sleeve 23 is arranged to be a cone; and the bevel is attached to the surface of the cone pressing sheet 19.

Through the above structure design, the cone pressing sheet 19 extrudes the cone of the end of the expansion sleeve 23, so that the end of the expansion sleeve 23 extends and starts to expand; and the friction force between the cone pressing sheet 19 and the expansion sleeve 23 is increased, and the expansion sleeve 23 makes contact with the inner wall of the expansion sleeve limiting housing 22 after expansion, so that the damping effect is achieved.

### Embodiment 3:

This embodiment is different from the Embodiment 2 in that the structure of the expansion sleeve 23 is different, specifically, the expansion sleeve 23 in this embodiment is arranged to be a hollow cylinder; a splitting through groove is formed in one side of the expansion sleeve 23 in an axis direction; a connecting rod 30 is inserted in the splitting through groove; and the end, away from the expansion sleeve 23, of the connecting rod 30 is in inserted connection with the cone pressing sheet 19.

Through the above structure design, the cone pressing sheet 19 extrudes the end of the expansion sleeve 23, so that the expansion sleeve 23 extends and expands as well, meanwhile, the cone pressing sheet 19 is rapidly connected to the expansion sleeve 23 through the connecting rod 30, and at the moment, the friction force can act on the first assembly 26 and the second assembly 27 at the same time.

1. A damping type universal arm support, comprising:
a first assembly (26) and a second assembly (27) which are symmetrically arranged and are both used for connecting objects;
a damping sleeve piece (28) which is arranged at a position between the first assembly (26) and the second assembly (27), wherein the first assembly (26) and the second assembly (27) are movably connected through the damping sleeve piece (28); and
a limiting assembly (29) which is arranged at the end of the damping sleeve piece (28) and is used for limiting the damping sleeve piece (28) and moreover used for limiting the rotation of the first assembly (26) and the second assembly (27).

2. The damping type universal arm support according to claim 1, wherein the first assembly (26) comprises a first movable arm (15); an upper end of the first movable arm (15) is sleeved with a first ball head limiting housing (11); a lower end of the first ball head limiting housing (11) is in threaded connection with the first movable arm (15) through a first fixing screw (9); a first ball seat (7) is placed at the bottom of the inner side of the first ball head limiting housing (11); a first ball head (5) is connected to the top of the first ball head limiting housing (11) in a ball hinge mode; a first connecting piece (3) is detachably connected to the top of the first ball head (5); a first locking screw (1) is arranged at an upper end of the first connecting piece (3); a first ejector rod (13) is arranged in the first movable arm (15); an upper end of the first ejector rod (13) penetrates through the first fixing screw (9) to be attached to the bottom of the first ball seat (7); the first ejector rod (13) is vertically slidably connected to the first fixing screw (9); a lower end of the first ejector rod (13) extends to the inner side of a lower end of the first movable arm (15);
the second assembly (27) comprises a second movable arm (16); an upper end of the first movable arm (15) is sleeved with a second fixing screw (10); a lower end of the second fixing screw (10) is in threaded connection with the second movable arm (16) through a second ball head limiting housing (12); a second ball seat (8) is placed at the bottom of the inner side of the second fixing screw (10); a second ball head (6) is connected to the top of the second fixing screw (10) in a ball hinge mode; a second connecting piece (4) is detachably connected to the top of the second ball head (6); a second locking screw (2) is arranged at an upper end of the second connecting piece (4); a second ejector rod (14) is arranged in the second movable arm (16); an upper end of the second ejector rod (14) penetrates through the second ball head limiting housing (12) to be attached to the bottom of the second ball seat (8); the second ejector rod (14) is vertically slidably connected to the second ball head limiting housing (12); and a lower end of the second ejector rod (14) extends to the inner side of a lower end of the second movable arm (16).

3. The damping type universal arm support according to claim 2, wherein the damping sleeve piece (28) comprises a cone pressing sheet (19), an expansion sleeve limiting housing (22), and an expansion sleeve (23); the cone pressing sheet (19) is in inserted connection with the bottom of one side of the first movable arm (15); the expansion sleeve limiting housing (22) is in inserted connection with the bottom of one side of the second movable arm (16); a first cover (20) is arranged on the outer side of the first movable arm (15); the outer side of the cone pressing sheet (19) is sleeved with the first cover (20); the first cover (20) is fixedly connected to the first movable arm (15) through a screw; the outer side of the expansion sleeve limiting housing (22) is sleeved with a second cover (21); the second cover (21) is fixedly connected to the second movable arm (16) through a screw; the expansion sleeve (23) is placed in the expansion sleeve limiting housing (22); the end, away from the first movable arm (15), of the cone pressing sheet (19) stretches into the expansion sleeve limiting housing (22); and the end, located on the inner side of the expansion sleeve limiting housing (22), of the cone pressing sheet (19) is attached to the inner side of one end of the expansion sleeve (23).

4. The damping type universal arm support according to claim 3, wherein the limiting assembly (29) comprises a bevel nut (17), a bevel sliding block (18), and a locking wrench (24); one end of the bevel nut (17) stretches into the inner side of the lower end of the first movable arm (15) and sequentially penetrates through the cone pressing sheet (19), the first cover (20), the expansion sleeve (23) and the expansion sleeve limiting housing (22) to extend to the inner side of the lower end of the second movable arm (16); the end, located on the inner side of the lower end of the first movable arm (15), of the bevel nut (17) is arranged to be a bevel; a lower end of the first ejector rod (13) is attached to the bevel of the end of the bevel nut (17); the bevel sliding block (18) is placed in the lower end of the second movable arm (16); the end, close to the bevel nut (17), of the bevel sliding block (18) is arranged to be a bevel; the lower end of the second ejector rod (14) is attached to the bevel of the end of the bevel sliding block (18); one end of the locking wrench (24) penetrates through the bevel sliding block (18) to stretch into the bevel nut (17); and the locking wrench (24) is in threaded connection with the bevel nut (17).

5. The damping type universal arm support according to claim 4, wherein the outer side of the locking wrench (24) is in threaded connection with a decoration cover (25).

6. The damping type universal arm support according to claim 3, wherein the expansion sleeve (23) is arranged to be a hollow cylinder, and expansion grooves are alternately formed in two ends of the expansion sleeve (23); the inner side of the end, close to the cone pressing sheet (19), of the expansion sleeve (23) is arranged to be a cone; and the bevel is attached to the surface of the cone pressing sheet (19).

7. The damping type universal arm support according to claim 3, wherein the expansion sleeve (23) is arranged to be a hollow cylinder; a splitting through groove is formed in one side of the expansion sleeve (23) in an axis direction; a connecting rod (30) is inserted in the splitting through groove; and the end, away from the expansion sleeve (23), of the connecting rod (30) is in inserted connection with the cone pressing sheet (19).
